(19) United States
(12) Patent Application Publication
(10) Pub. No.: US 2013/0113741 A1
(43) Pub. Date: May 9, 2013

(54) SYSTEM AND METHOD FOR SEARCHING KEYWORDS

(71) Applicant: Samsung Electronics Co., Ltd., Gyeonggi-do (KR)

(72) Inventors: Kyung Hwa KIM, Seoul (KR); Dong Jun SHIN, Seoul (KR)

(73) Assignee: SAMSUNG ELECTRONICS CO., LTD., Gyeonggi-do (KR)

(21) Appl. No.: 13/667,249

(22) Filed: Nov. 2, 2012

(30) Foreign Application Priority Data
Nov. 8, 2011 (KR) 10-2011-0115917

(51) Int. Cl. G06F 3/041; G06F 3/01

(52) U.S. Cl. 345/173; 345/156

(57) ABSTRACT

A keyword search system and method are adapted to mobile devices for determining whether an event occurs that adds a keyword input field during the display of a first keyword input field; displaying, if the event occurs, a second keyword input field; and displaying first and second search results related to first and second keywords input to the first and second keyword input fields, respectively.

### CLAIM OF PRIORITY

This application claims, pursuant to 35 USC 119(a), priority to, and the benefit of the earlier filing date of, that patent application filed in the Korean Intellectual Property Office on Nov. 8, 2011 and assigned Serial Number 10-2011-0115917, the entire disclosure of which is incorporated by reference herein.

### BACKGROUND OF THE INVENTION

1. Field of the Invention

This invention relates to a system and method that allows a user to input a keyword in a keyword input field via a keypad and displays the keyword search result in a search result display field.

2. Description of the Related Art

The mobile device market is growing rapidly because there are many types of mobile devices that are equipped with a variety of applications to suit the user's needs. In particular, unlike conventional mobile devices that can provide only limited functions, smart phones can provide a variety of services, e.g., taking pictures or videos, playback of audio and video, online games, broadcast listening, Social Network Services, etc., via corresponding applications that can be downloaded from online market websites, etc.

Mobile devices are generally equipped with keyword search systems. When a keyword is input to mobile devices via a keypad, conventional keyword search systems in the prior art search the storage units of the mobile devices or web portals, e.g., an App Store, for the keyword, and display the related results.

However, conventional keyword search systems in the prior art make it difficult for users to search for information via keywords. That is, such conventional keyword search systems only display the search result regarding only a single keyword. In addition, when several keywords are input to the mobile device, conventional keyword search systems in the prior art cannot differentiate the input keywords from each other and cannot display the search results regarding the respective keywords.

### SUMMARY OF THE INVENTION

The present invention has been made in view of the above problems to solve such problems, and provides a system and method that can distinguish a number of input keywords from each other and display the search results regarding the respective keywords.

In accordance with an exemplary embodiment of the invention, the invention provides a keyword search method which includes: determining whether an event occurs that adds a keyword input field during the display of a first keyword input field; displaying, if the event occurs, a second keyword input field; and displaying first and second search results related to first and second keywords input to the first and second keyword input fields, respectively.

In accordance with another exemplary embodiment of the invention, the invention provides a keyword search system which includes: a touch screen for creating a touch event in response to a user's touch gesture; a controller for ascertaining that the touch gesture corresponds to an event for adding a keyword input field, and adding and displaying a keyword input field; and a display unit for displaying a number of keyword input fields and the search results related to the input fields, respectively, under the control of the controller.

### BRIEF DESCRIPTION OF THE DRAWINGS

The features and advantages of the invention will become more apparent from the following detailed description in conjunction with the accompanying drawings, in which:

FIG. 1 illustrates a configuration of a mobile device according to an exemplary embodiment of the present invention;

FIG. 2 illustrates a detailed view of a keyword searching unit according to the exemplary embodiment of the present invention;

FIG. 3 illustrates a flow chart that describes a keyword search method according to the exemplary embodiment of the present invention;

FIGS. 4A to 4E illustrate a progression of screens to describe a method for displaying and adding a keyword input field according to the exemplary embodiment of the present invention;

FIGS. 5A and 5B illustrate a progression of screens to describe a method for removing a keyword input field according to the exemplary embodiment of the present invention;

FIGS. 6A to 6C illustrate a progression of screens to describe another exemplary embodiment of a method for adding a keyword input field according to the present invention; and

FIGS. 7A to 7B illustrate a progression of screens to describe a further exemplary embodiment of a method for displaying a keyword input field according to the present invention.

### DETAILED DESCRIPTION OF THE INVENTION

Hereinafter, preferred embodiments of the keyword search system and method according to the present invention are described in detail with reference to the accompanying drawings. The terms or words described in the present description and the claims should not be limited by a general or lexical meaning, but instead should be analyzed as a meaning and a concept through which the inventor defines and describes the invention, to comply with the idea of the invention. Therefore, one skilled in the art will understand that the embodiments disclosed in the description and configurations illustrated in the drawings are only preferred embodiments, but instead there may be various modifications, alterations, and equivalents thereof to replace the embodiments at the time of filing this application. The principles and features of this invention may be employed in varied and numerous embodiments without departing from the scope of the invention.

Although the drawings represent an exemplary embodiment of the invention, the drawings are not necessarily to scale and certain features may be exaggerated or omitted in order to better illustrate and explain the invention. The same reference numbers are used throughout the drawings to refer to the same or like parts. In the following description, a detailed explanation of known related functions and constructions may be omitted to avoid unnecessarily obscuring the subject matter of the present invention.

Among the terms set forth herein, a terminal or mobile device refers to any kind of device capable of processing data which is transmitted or received to or from any external entity. The terminal or mobile device may display icons or menus on a screen to which stored data and various executable functions are assigned or mapped. The terminal or mobile device may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

It should be understood that the keyword search system and method according to the invention can be applied to all types of electronic devices including mobile devices if they have input units for receiving keywords, e.g., touch screens. The mobile device includes any known information communication devices, multimedia devices, and their applications, for example, mobile phones, smart phones, tablet personal computers, hand-held PCs, Portable Multimedia Players (PMPs), Personal Digital Assistants (PDAs), audio players (e.g., MP3 player), mobile game devices, digital broadcast players, etc. In the following description, it is assumed that the keyword search system and method of the present invention, in an exemplary embodiment for illustrative purposes, is applied to smart phones.

The keyword search system and method according to the invention provides a keyword search function, via a number of keyword input fields and display fields that display the search results based on the keywords in the input fields respectively. The keyword input field refers to a display area on the display unit that displays a keyword that the user inputs via a keypad. The search result display field refers to a display area that displays a search result based on a keyword in a keyword input field. In addition, the keyword search system and method according to the invention provides a keyword removal function that removes one of a number of keyword input fields and the corresponding search result display field according to a user's request. Additionally, the keyword search system and method according to the invention also provides an update function that automatically updates and displays, when the keyword search function is executed according to a user's request, the latest search result. In the following description, the features of the invention are explained in greater detail referring to the accompanying drawings. A detailed description of known functions and configurations incorporated herein will be omitted when such a description may obscure the subject matter of the invention.

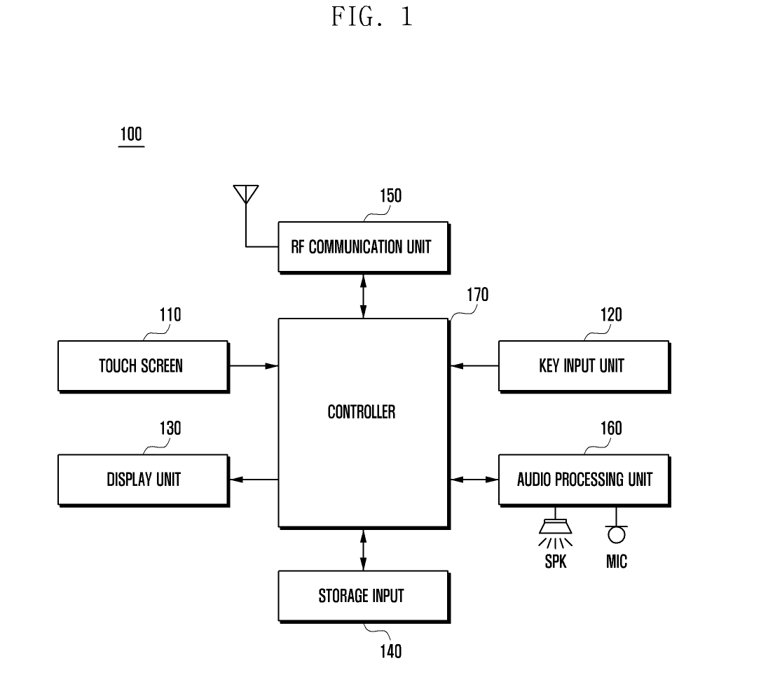

FIG. 1 illustrates a configuration of a mobile device according to an exemplary embodiment of the present invention. Referring to FIG. 1, the mobile device 100 includes a touch screen 110, a key input unit 120, a display unit 130, a storage input 140, an RF communication unit 150, an audio processing unit 160, a speaker SPK, a microphone MIC, and a controller 170.

The touch screen 110 is installed onto or incorporated into the display unit 130. The touch screen 110 senses a user's touch gestures, creates touch events with corresponding signals in response to the sensed touch gestures, and transfers the corresponding signals to the controller 170. The controller 170 identifies touch gestures according to the received signals, and performs corresponding control operations. Examples of the touch gestures are touch, tap, double tap, press, drag, drag and drop, sweep, etc. ‘Touch’ refers to a gesture that presses one point on the touch screen. ‘Tap’ refers to a gesture that strikes gently on one point on the touch screen. ‘Double tap’ refers to a gesture that briefly successively taps twice on one point on the touch screen. ‘Press’ refers to a gesture that contacts one point on the touch screen for longer than the ‘tap’ gesture and then releases the one point by withdrawing the contact with the screen. ‘Drag’ refers to a gesture that touches one point on the touch screen and then moves to another location without removing the touch. ‘Drag’ is also called ‘scroll.’ ‘Drag and drop’ refers to a gesture that selects a virtual object by grabbing and dragging the virtual object to a different location or onto another virtual object, and then withdrawing the contact with the screen. ‘Sweep’ refers to a gesture that brushes lightly on the touch panel with the user's finger or an object. ‘Sweep’ is also called ‘flick.’ The controller 170 can distinguish ‘drag’ and ‘sweep’ via the speed of moving a corresponding object on the touch panel. The touch screen 110 may be implemented with various types of sensors, such as a resistive type, a capacitive type, an electromagnetic induction type, a pressure type, etc.

The key input unit 120 includes a number of input keys and function keys that receive numbers, symbols, and letters, and set a variety of functions in the mobile device 100. The function keys may include direction keys, side keys, shortcut keys, etc., which are set to perform specific functions. The key input unit 120 creates key signals, related to a user's settings and function controls of the mobile device 100, and transfers the key signals to the controller 170. Examples of the key signals are signals for turning on/off the mobile device 100, adjusting the volume, turning on/off the screen, etc. The controller 170 controls corresponding components according to the key signals. The key input unit 120 may be implemented with a QWERTY keypad, a 3×4 keypad, a 4×3 keypad, etc., which includes a number of keys. When the mobile device 100 is designed to include a full touch screen, the key input unit 120 may be implemented as side keys for turning on/off the screen or the mobile device 100, which are installed to the side of the case of the mobile device 100.

The display unit 130 converts visual data, which may include video data, from the controller 170 into analog data and displays images based on the analog data. The display unit 130 displays a variety of screens according to the control of the controller 170, e.g., a lock screen, a home screen, an application execution screen, a search screen, a menu screen, a keypad screen, a message writing screen, an Internet screen, etc. The lock screen refers to an image screen displayed when the display unit 130 is turned on and put into a lock state to not respond to any inputs except a specific unlocking touch event. When the specific unlocking touch event occurs in order to release the lock screen, the controller 170 switches the lock screen to a home screen or an application execution screen. The home screen refers to an image screen including a number of icons corresponding to applications. When the user touches/selects one of application icons, the controller 170 executes the application and displays the corresponding image as the application execution screen. The search screen refers to an image screen that displays at least one keyword input field and the keyword search result display field corresponding to the keyword in the keyword input field. In another embodiment, the display unit 130 may display a number of search screens under the control of the controller 170. When part of a number of search screens are displayed, the user can scroll to move the screens and view the other screens. Alternatively, the display unit 130 may display a number of search screens in a layer; that is, the search screens may be arranged in a hierarchy, with different search screens accessible in different layers of the hierarchy. In addition, the display unit 130 may also display search screen tags corresponding to a number of search screens. When the user selects one of the search screen tags, the controller 170 controls the display unit 130 to display a search screen corresponding to the selected search screen tag.

The display unit 130 can also display different screens under the control of the controller 170. For example, the display unit 130 can display a screen with two separate areas or regions simultaneously, with one area displaying a keypad screen and the other area displaying a search screen. Alternatively, the display unit 130 may display the main screen in one area and a sub-screen in the other area, overlapping on/under the main screen; for example, a search screen and a keypad screen overlapping thereon. The display unit 130 may be implemented with a flat display panel, such as a Liquid Crystal Display (LCD), an Organic Light Emitting Diode (OLED), an Active Matrix Organic Light Emitting Diodes (AMOLED), or the like.

The storage unit 140 stores an operating system (OS) for the mobile device, application programs required for the operations of the functions according to the invention, and data related to the mobile device. The storage unit 140 includes a program storage area and a data storage area.

The data storage area stores data created when the mobile device 100 operates. The data storage area stores data downloaded from an external system, e.g., contacts, images, documents, videos, text messages, emails, audio files, etc. The data storage area stores the screens, described above, to be displayed on the display unit 130 and/or the touch screen 110. For example, the keypad screen may be a 3×4 keypad screen or a QWERTY keypad screen. The menu screen may include a key for switching screens, e.g., a return key for returning to a previous screen, a key for controlling a currently executed application, etc. The data storage area also serves as a buffer that temporarily stores data created when a message, an image, a web page, a document, etc. is copied to be pasted. The data storage area may also store preference values, e.g., screen brightness, a value to determine whether to enable a vibration mode of the mobile device 100 when a touch occurs, a value to determine whether to automatically rotate a screen, etc. In particular, the data storage area stores search screens that display keywords and the keyword search results. When the user executes the keyword search function in the mobile device 100, the controller 170 updates the keyword search results.

The program storage area stores the operating system (OS) for booting the mobile device 100 and controlling the components in the mobile device 100. The program storage area also stores a number of applications for supporting a variety of user functions, for example, a web browser for connecting to Internet servers, an audio function for playing audio files, such as MP3 files, an image outputting function for reproducing photographs, a video playback function, etc. In particular, the program storage area stores a keyword search application program that provides a keyword search function, a keyword deletion function, an update function, etc. The keyword search application program searches the data storage area for data corresponding to an input keyword. In addition, the keyword search application program can search an App Store, e.g., a database or repository of applications, applets, and/or apps for an application or other software corresponding to an input keyword. Additionally, the keyword search application program can also search the Internet for information corresponding to an input keyword.

The RF communication unit 150 establishes communication channels for a voice/video call or data communication with other communication systems, under the control of the controller 170. The RF communication unit 150 includes an RF transmitter for up-converting the frequency of signals to be transmitted and for amplifying the signals, and an RF receiver for low-noise amplifying received RF signals and down-converting the frequency of the received RF signals. The RF communication unit 150 may further include a mobile communication module such as a 3-, 3.5-, or 4-Generation module, for example, a short range communication module (e.g., a Wi-Fi module), a digital broadcast module (e.g., a DMB module), etc. The RF communication unit 150 is wirelessly connected to Internet web portals, e.g., the App Store, etc., under the control of the controller 170.

The audio processing unit 160 transfers audio signals, output from the controller 170, to the speaker SPK. The audio processing unit 160 also transfers audio signals such as voices, input via the microphone MIC, to the controller 170. The audio processing unit 160 converts voice/audio data into audio signals and then outputs such audio signals via the speaker SPK, which may generate and output audible sounds, according to the control of the controller 170. The audio processing unit 160 also converts audio signals such as voices, received via the microphone MIC, into digital signals and then transfers the digital signals to the controller 170.

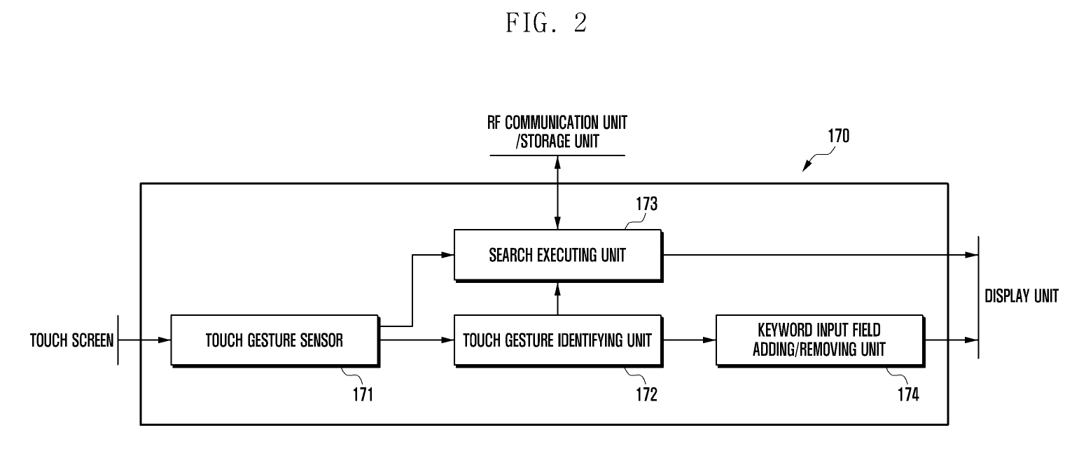

The controller 170 controls the entire operation of the mobile device 100 and the signals flowing among the components therein. The controller 170 controls the electric power supplied to the components from a battery or other power source. In particular, the controller 170 executes applications stored in the program storage area. The controller 170 includes a keyword search unit as shown in FIG. 2.

FIG. 2 illustrates a detailed view of a keyword search unit according to the exemplary embodiment of the present invention. The keyword search unit may be included in or separate from the controller 170. In the following description of the exemplary embodiment of the present invention, it is assumed that the keyword search unit is included in the controller 170.

Referring to FIG. 2, the controller 170 includes a touch gesture sensor 171, a touch gesture identifying unit 172, a search executing unit 173, and a keyword input field adding/removing unit 174.

The touch gesture sensor 171 is connected to the touch screen 110. The touch gesture sensor 171 senses touch gestures on the touch screen 110 while at least one keyword input field is being displayed.

The touch gesture identifying unit 172 identifies the sensed touch gesture. In the exemplary embodiment of the invention, identifying a sensed touch gesture may be used for identifying a command for displaying a keypad, performing a keyword search, adding or removing a keyword input field. etc. More specifically, when the user taps a keyword input field displayed on the touch screen 110, the touch gesture sensor 171 senses the tap event, generates a corresponding electrical signal, and transfers the corresponding signal to the touch gesture identifying unit 172. In that case, the touch gesture identifying unit 172 may identify the received signal as a command for displaying the keypad or a command for adding a keyword input field, for example. Likewise, when the user taps a search button displayed on the touch screen 110, the touch gesture sensor 171 senses the tap event, generates a corresponding electrical signal, and transfers the corresponding signal to the touch gesture identifying unit 172. In that case, the touch gesture identifying unit 172 may identify the received signal as a command for performing a search based on the input keyword or a command for adding a keyword input field, for example. In addition, when the user taps a removal button on the touch screen 110, the touch gesture sensor 171 senses the tap event, generates a corresponding electrical signal, and transfers the corresponding signal to the touch gesture identifying unit 172. The touch gesture identifying unit 172 may identify the received signal as a command for removing the keyword input field and the search result display field, for example.

The search executing unit 173 executes a search function based on an input keyword, according to a user's search request. When the touch gesture identifying unit 172 identifies the touch gesture as a command for performing a search based on an input keyword, the search executing unit 173 performs a search function. When the search command is to search the data storage area for the input keyword, the search executing unit 173 searches the data storage area for information related to the input keyword and displays any found information on the display unit 130. Alternatively, if such an information search is performed during the execution of an Internet application, e.g., App Store, the search executing unit 173 searches information related to the input keyword using the Internet portal, via the RF communication unit 150, and displays any found information on the display unit 130.

The keyword input field adding/removing unit 174 adds and displays a keyword input field on the touch screen 110, according to a user's request for adding a keyword input field. Likewise, the keyword input field adding/removing unit 174 also removes a keyword input field and the search result display field from the touch screen 110, according to a user's request for removing a keyword input field. That is, the keyword input field adding/removing unit 174 can add a search screen or remove a user's selected search screens displayed on the touch screen 110.

In addition, the mobile device 100 may further include a camera module, a GPS module, a sensor module for sensing a change in the location and state of the mobile device 100, an interface module for connecting to external systems, such as networks including the Internet, in wired and/or wireless mode, etc. With the convergence of digital devices, there may be many digital devices and modifications thereof, not listed in the description of the present invention, and so, it will be appreciated that they can also be included in the mobile device 100. Also, It will be appreciated that, according to the purpose and objectives of the invention, the mobile device 10 may be implemented by omitting a particular element from the exemplary configuration or replacing a particular element with other elements.

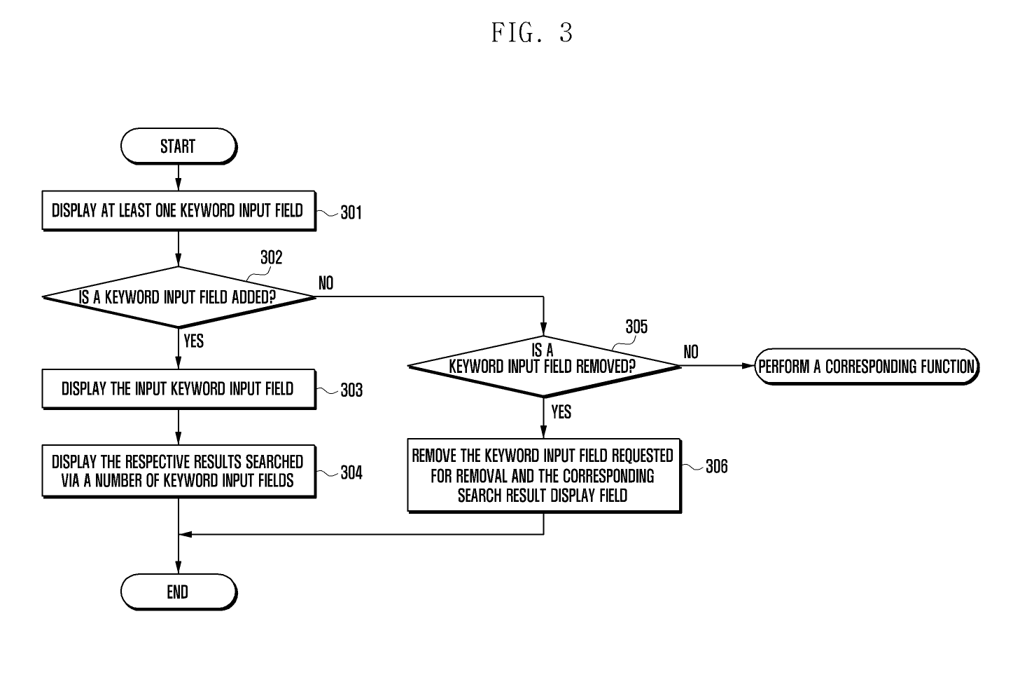

FIG. 3 illustrates a flow chart that describes a keyword search method according to the exemplary embodiment of the present invention.

The mobile device 100 operates in an idle mode that refers to a state before executing a keyword search function. For example, during the idle mode, the controller 170 displays a home screen or an application execution screen on the display unit 130. When the user requests the execution of a keyword search function, the controller 170 executes the keyword search function, and displays at least one keyword input field on the display unit 130 in step 301. In addition, the controller 170 can also display a keyword search result display field corresponding to the keyword input field on the display unit 130. The search result display field may include a search result that was acquired before the current search. In that case, the controller 170 repeats the search of a database (e.g., the data storage area of the storage input 140, web portals, App Store, etc.) for the previous keyword, and displays the re-searched result instead of the previous search result. The controller 170 can display a number of keyword input fields in a specific and common hierarchical layer of screens. In that case, the controller 170 displays a keyword input field and the search result display field thereunder.

When the controller 170 senses the touch gesture while the keyword input field is displayed at step 301, the controller 170 determines in step 302 whether the touch gesture corresponds to a command for adding a keyword input field. When the controller 170 ascertains that the touch gesture is a command for adding a keyword input field at step 302, the controller 170 adds and displays a keyword input field on the display unit 130 in step 303. The keyword input field may be displayed on the top or bottom, or alternatively in any other part, of the display area of the display unit 130. If the user inputs a keyword via the added keyword input field, the controller 170 performs a search based on the input keyword. After that, the controller 170 displays the search results via a number of keyword input fields, respectively in step 304 and the method ends or performs other functions, as described herein.

However, referring to step 302, when the controller 170 ascertains that the touch gesture is not a command for adding a keyword input field at step 302, the controller 170 further determines whether the touch gesture is a command for removing a keyword input field in step 305. When the controller 170 ascertains that the touch gesture is a command for removing a keyword input field at step 305, the controller 170 removes the keyword input field requested for removal and removes the corresponding search result display field in step 306 and the method then ends or performs other functions as described herein. However, when the controller 170 ascertains in step 305 that the touch gesture is not a command for removing a keyword input field, the controller 170 performs a corresponding operation, e.g., displaying a keyword input via a keypad in a corresponding keyword input field.

After performing steps 304 and 306, the controller 170 determines whether to terminate the keyword search function. When the controller 170 ascertains that a touch is not made to terminate the keyword search function, the controller 170 returns to one of the preceding steps, such as step 302, or alternatively step 301. However, when the controller 170 ascertains that a touch is made to terminate the keyword search function, the controller 170 stores the search results in the data storage area. After that, the keyword search function is re-executed, and the controller 170 automatically updates the search results and displays updated search results on a screen of the display unit 130.

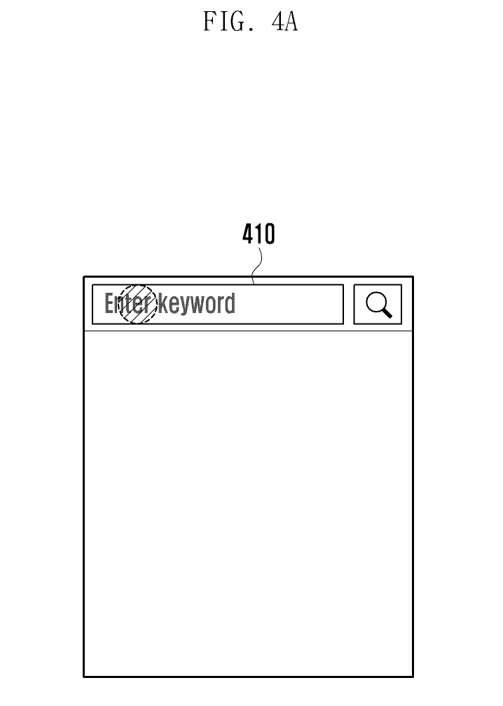

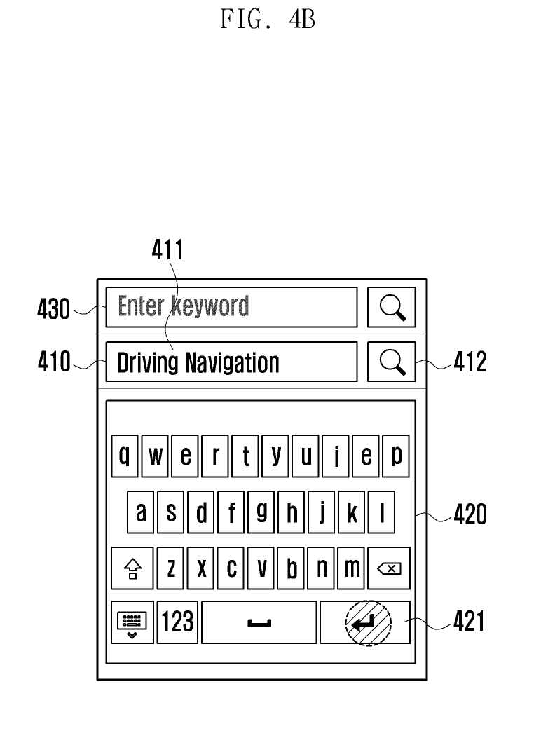

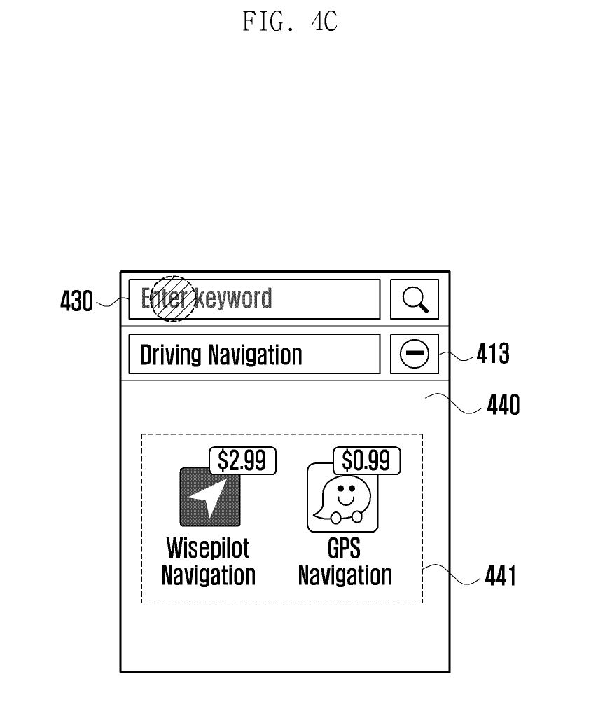

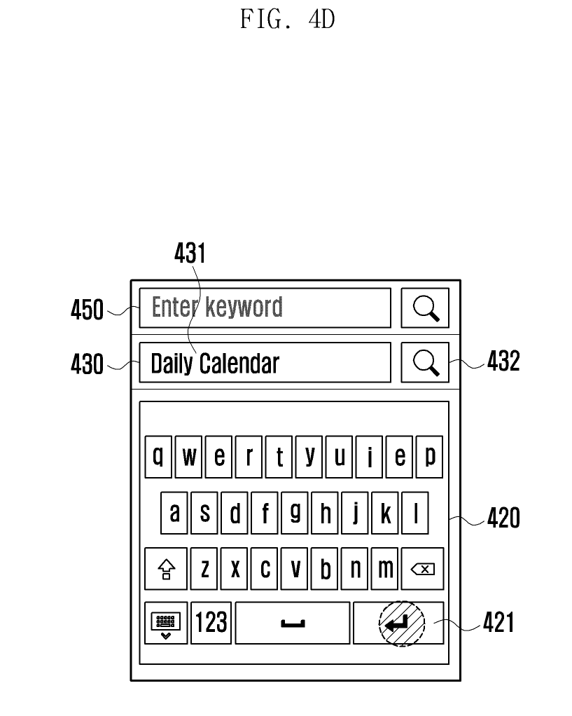

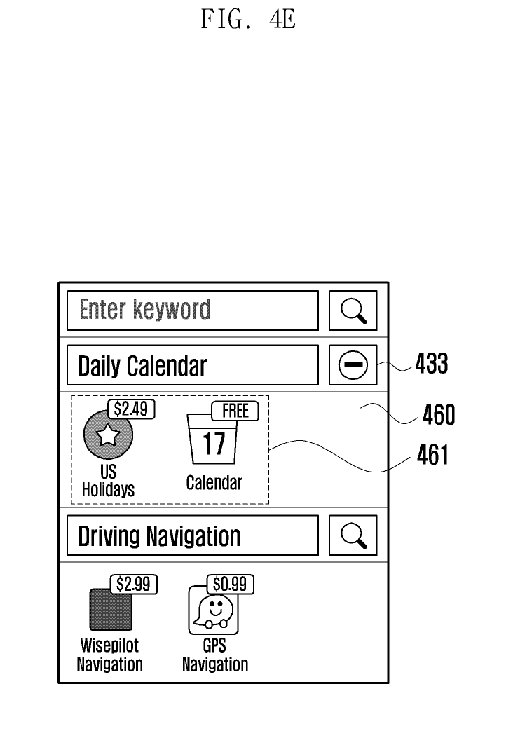

FIGS. 4A to 4E illustrate a progression of screens to describe a method for displaying and adding a keyword input field according to the exemplary embodiment of the present invention.

As shown in FIG. 4A, the controller 170 controls the display unit 130 to display a first keyword input field 410 in the touch screen 110 of the display unit 130, for example, when performing steps 301-304 in FIG. 3.

As shown in FIG. 4B, when the user taps the first keyword input field 410 shown in FIG. 4A, the controller 170 controls the display unit 130 to display a keypad 420 below the first keyword input field 410. When the user makes a touch for selecting a keyword input field in which no keyword has been input, the controller 170 identifies the touch as an event for adding a keyword input field. In that case, the controller 170 also controls the display unit 130 to display a second keyword input field 430 above the first keyword input field 410, as shown in FIG. 4C.

Referring back to FIG. 4B, the user can input a first keyword 411, i.e., ‘Driving Navigation,’ into the first keyword input field 410 via the keypad 420. When the user taps a first search button 412 of the first keyword input field 410 or the enter key 421 of the keypad 420, the controller 170 searches a database for information related to the first keyword 411 and displays the search result 441 in a first search result display field 440 shown in FIG. 4C, and also performs the removal of the keypad 420. The controller 170 also displays a first removal button 413, for example, as a minus sign in a circle, in place of the first search button 412, as shown in FIG. 4C.

The controller 170 can add keyword input fields on the display unit 130. As shown in FIG. 4C, when the user taps the second keyword input field 430, the controller 170 controls the display unit 130 to display the keypad 420 and a third keyword input field 450 below and above the second keyword input field 430, respectively, as shown in FIG. 4D. The user can input a second keyword 431, i.e., ‘Daily Calendar,’ into the second keyword input field 430 via the keypad 420. After that, as shown in FIG. 4D, when the user taps a second search button 432 of the second keyword input field 430 or the enter key 421 of the keypad 420, the controller 170 searches a database for information related to the second keyword 431 and displays the search result 461 on a second search result display field 460 shown in FIG. 4E, and also performs the removal of the keypad 420. The controller 170 also displays a second removal button 433, for example, as a minus sign in a circle, in place of the second search button 432, as shown in FIG. 4E.

As described above, the controller 170 controls the display unit 130 to display a number of keyword input fields in the hierarchical layer of screens. The controller 170 also controls the display unit 130 to display the keyword input fields and the keyword search result display fields therebelow respectively. When the controller 170 detects a user's touch for selecting a keyword input field in which no keyword has been input, the controller 170 identifies the touch as an event for adding a keyword input field. In that case, the controller 170 adds a keyword input field at the top or bottom of the display area of the display unit 130.

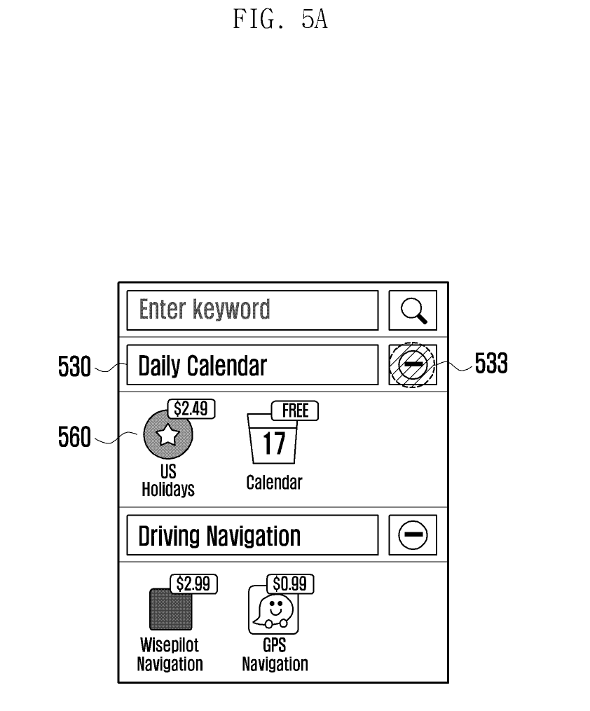

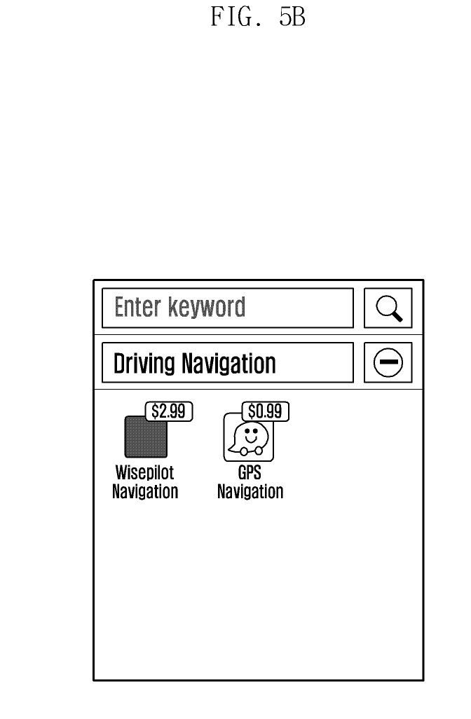

FIGS. 5A and 5B illustrate a progression of screens to describe a method for removing a keyword input field according to the exemplary embodiment of the present invention, for example, to perform steps 305-306 in FIG. 3.

When a tap occurs on a removal button 533, for example, as a minus sign in a circle, as shown in FIG. 5A, the controller 170 removes the keyword input field 530 and removes the search result display field 560, and displays the screen as shown in FIG. 5B.

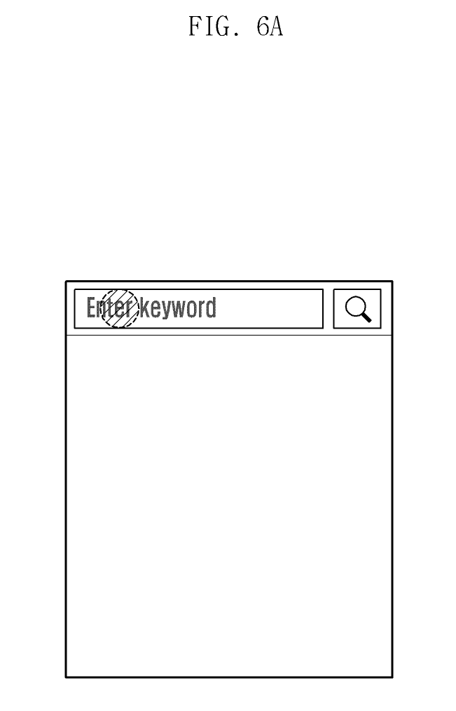

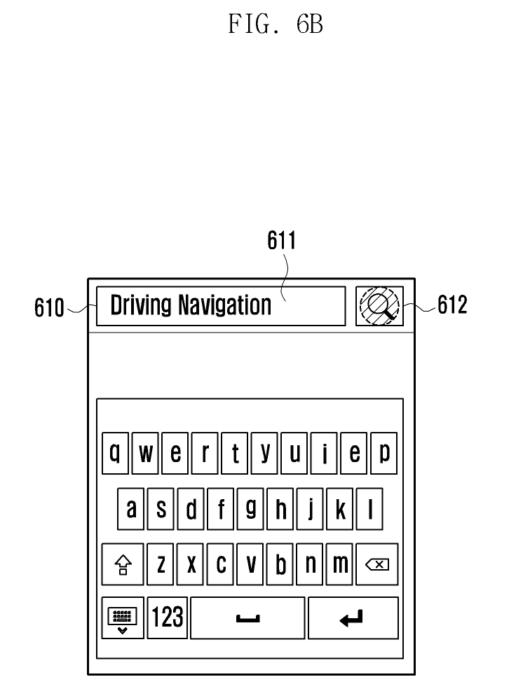

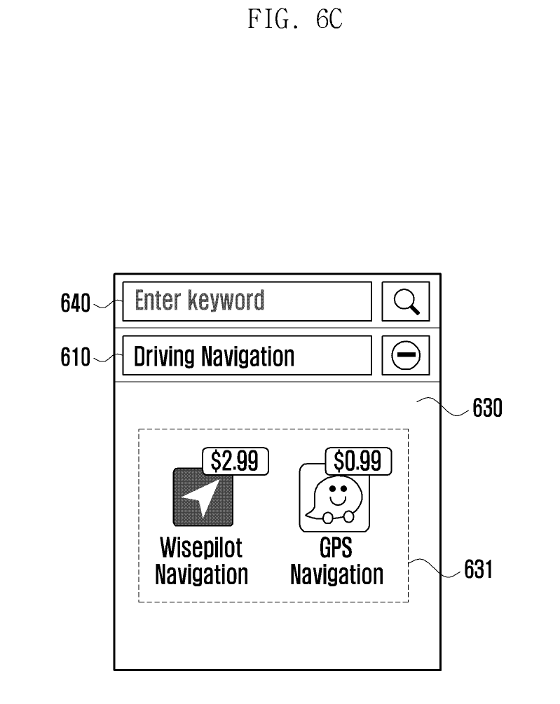

FIGS. 6A to 6C illustrate a progression of screens to describe another exemplary embodiment of a method for adding a keyword input field according to the present invention.

As shown in FIG. 6A, the controller 170 controls the display unit 130 to display a first keyword input field 610. Referring to FIG. 6A, when the user taps the first keyword input field 610, the controller 170 controls the display unit 130 to display a keypad 620 below the first keyword input field 610, as shown in FIG. 6B, to perform step 303 in FIG. 3. The user can input a first keyword 611 into the first keyword input field 610 via the keypad 620.

When the user taps a first search button 612 of the first keyword input field 610 or the enter key 621 of the keypad 620 in FIG. 6B, the controller 170 displays the first search result display field 630 below the first keyword input field 610 in FIG. 6C. After that, the controller 170 searches a database for information related to the first keyword 611 and displays the search result 631 in a first search result display field 630, to perform step 304 in FIG. 3. In addition, the controller 170 controls the display unit 130 to display a second keyword input field 640 above the first keyword input field 610, as shown in FIG. 6C, to perform step 303 in FIG. 3. If there is no search result regarding the first keyword 611, the controller 170 may not add the second keyword input field 640.

The controller 170 may identify a touch gesture for requesting a keyword search as an event for adding a keyword input field. That is, when the controller 170 detects a touch gesture for requesting a search based on an input keyword, the controller 170 may identify the touch gesture as an event for adding a keyword input field. In that case, the controller 170 adds a keyword input field to the top of the display area of the display unit 130 as shown in FIG. 6C.

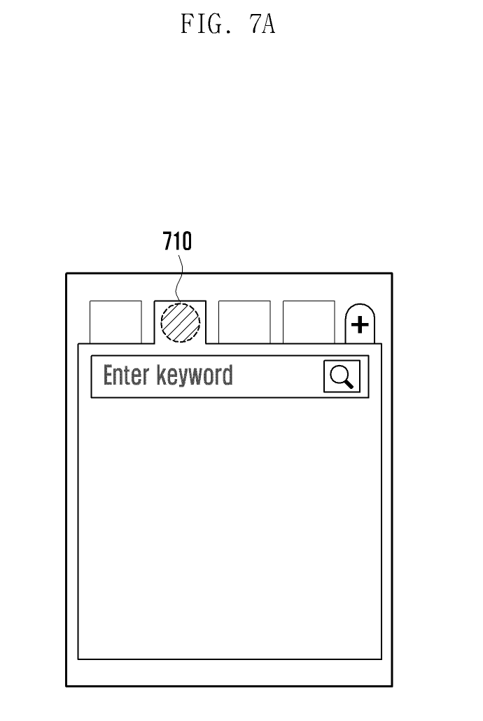

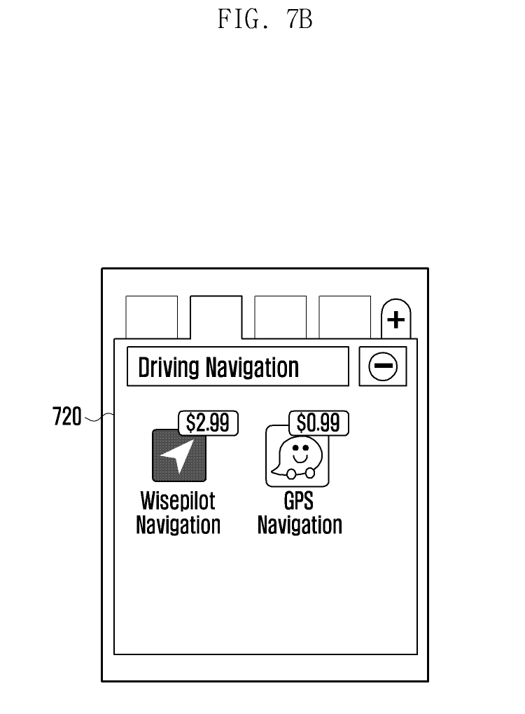

FIGS. 7A to 7B illustrate a progression of screens to describe a further exemplary embodiment of a method for displaying a keyword input field according to the present invention.

As shown in FIGS. 7A and 7B, the controller 170 controls the display unit 130 to display one of a number of search screens and the tabs and/or icons of the search screens. Each search screen includes one keyword input field and a corresponding search result display field. As shown in FIG. 7A, when the user taps one of the search screen tabs, such as tab 710, the controller 170 controls the display unit 130 to display the corresponding search screen 720 shown in FIG. 7B.

As described above, the keyword search system and method according to the invention can display a keyword input field, allowing the user to input keywords into the field, and display the search results.

As described above, the keyword search method according to the invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments of the invention as defined in the appended claims.

What is claimed is:

1. A keyword search method comprising:
determining whether an event occurs to add a second keyword input field to a display during the display of a first keyword input field on the display;
displaying, if the event occurs, the second keyword input field on the display; and
displaying, on the display, first and second search results, related to first and second keywords input into the first and second keyword input fields, respectively.

2. The method of claim 1, wherein the display of the second keyword input field comprises:
displaying the first and second keyword input fields in the layer.

3. The method of claim 2, wherein the display of the second keyword input field comprises:
displaying the first keyword input field on the display above the second keyword input field.

4. The method of claim 1, wherein the determination comprises:
selecting the first keyword input field in a state in which the first keyword is not input into the first keyword input field; and
identifying the occurred event as an event for adding the second keyword input field.

5. The method of claim 1, wherein the determination comprises:
creating an event for requesting a search in a state in which the first keyword is input into the first keyword input field; and
identifying the requested event as an event for adding the second keyword input field.

6. The method of claim 1, further comprising:
determining whether an event occurs to select removal of one of the first or second keyword input fields during the display of the first and second keyword input fields; and
removing the a selected keyword input field from among the first and second keyword input fields from the display if the removal event occurs.

7. The method of claim 6, wherein the removal of the first keyword input field comprises:
removing the first search result from the display.

8. The method of claim 1, further comprising:
executing a keyword search function;
searching a database for information related to the first keyword; and
updating the display with the first search result.

9. A keyword search system comprising:
a touch screen for creating a touch event in response to a user's touch gesture;
a controller for ascertaining that the touch gesture corresponds to an event for adding a first keyword input field, and for adding and displaying the first keyword input field to the touch screen; and
a display unit for displaying, on the touch screen, a number of keyword input fields, including the first keyword input field, and search results related to the keyword input fields, respectively, under the control of the controller.

10. The system of claim 9, wherein the display unit displays a number of keyword input fields in the layer.

11. The system of claim 9, wherein the touch screen includes a display area, and the display unit displays the added first keyword input field on the top or bottom of the display area.

12. The system of claim 9, wherein the controller comprises:
a touch gesture sensor for sensing a touch gesture on the touch screen;
a touch gesture identifying unit for identifying the sensed touch gesture; and
a keyword input field adding/removing unit for controlling the display unit to add and display, if the sensed touch gesture corresponds to an event for adding a keyword input field, a second keyword input field, and to remove, if the sensed touch gesture corresponds to an event for removing a keyword input field, a corresponding displayed keyword input field selected from the first and second keyword input fields.

13. The system of claim 12, wherein the touch gesture identifying unit identifies the sensed touch gesture, if the sensed touch gesture corresponds to a selection of a keyword input field in which no keyword has been input, as an event for adding the second keyword input field.

14. The system of claim 12, wherein the touch gesture identifying unit identifies the sensed touch gesture, if the sensed touch gesture corresponds to requesting a search based on a keyword input to the first keyword input field, as an event for adding the second keyword input field.

15. A non-transitory computer-readable medium including a set of computer readable instructions that, when executed by a processor, perform a keyword search method, the keyword search method comprising:
determining whether an event occurs to add a second keyword input field to a display during the display of a first keyword input field on the display;
displaying, if the event occurs, the second keyword input field on the display; and
displaying, on the display, first and second search results, related to first and second keywords input into the first and second keyword input fields, respectively.

16. The non-transitory computer-readable medium of claim 15, wherein the determination comprises:
selecting the first keyword input field in a state in which the first keyword is not input into the first keyword input field; and
identifying the occurred event as an event for adding the second keyword input field.

17. The non-transitory computer-readable medium of claim 15, wherein the determination comprises:
creating an event for requesting a search in a state in which the first keyword is input into the first keyword input field; and
identifying the requested event as an event for adding the second keyword input field.

18. The non-transitory computer-readable medium of claim 15, further comprising:
determining whether an event occurs to select removal of one of the first or second keyword input fields during the display of the first and second keyword input fields; and
removing a selected keyword input field from among the first and second keyword input fields from the display if the removal event occurs.

19. The non-transitory computer-readable medium of claim 18, wherein the removal of the first keyword input field comprises:
removing the first search result from the display.

20. The non-transitory computer-readable medium of claim 15, further comprising:
executing a keyword search function;
searching a database for information related to the first keyword; and
updating the display with the first search result.
